(19) United States
(12) Patent Application Publication
(10) Pub. No.: US 2013/0234685 A1
(43) Pub. Date: Sep. 12, 2013

(54) HIGHLY LINEAR PROGRAMMABLE V-I CONVERTER USING A COMPACT SWITCHING NETWORK

(71) Applicant: Sreenath Thoka, San Jose, CA (US)

(72) Inventor: Sreenath Thoka, San Jose, CA (US)

(73) Assignee: QUALCOMM ATHEROS, INC, San Jose, CA (US)

(21) Appl. No.: 13/413,065

(22) Filed: Mar. 6, 2012

(51) Int. Cl. G05F 1/10

(52) U.S. Cl. 323/282

(57) ABSTRACT

A programmable voltage to current converter is described that is highly linear and may be implemented with a compact MOSFET switching network. With this design, the power consumption is also minimized. The programmable voltage to current converter comprises a switch network comprising one or two sets of N switches and one or two sets of N resistors, an op amp, and a current buffer MOSFET. The output current is independent of the characteristics of the one or two sets of N switches. To implement a single-ended converter, the switch network comprises one set of N resistors and one set of N switches. To implement a differential-ended converter, the switch network comprises two sets of N resistors and two sets of N switches.

### BACKGROUND

The present specification describes embodiments that generally relate to programmable voltage to current (V-I) converters in electronic circuits and specifically to embodiments utilizing switching networks with resistive ladders structures.

Programmable V-I converters may use relatively large MOS (or MOSFET) switches to program the switch network that implement the V-I conversion. The MOS switches may be large in order to have an on-resistance that is a small percentage of the V-I resistor or fixed resistor of the switch network; otherwise the conversion may lack linearity. Some existing V-I converter designs focus on reducing the non-linear contribution of the MOS switches since the MOS switches may be located in the signal path. Due to the presence of the MOS switches in the signal path, the maximum linearity achievable may be limited. The MOS switches may utilize a large amount of silicon area in order to meet the performance objectives. Also, some existing V-I converter designs may utilize a high swing operational amplifier (op amp). The larger silicon area of the MOS switches also drive higher power consumption.

### SUMMARY

Various embodiments are described for a programmable V-I converter that is highly linear and may be implemented with MOSFET devices that have a compact switching network design. With the design, the power consumption is also minimized. In some embodiments, the programmable V-I converter comprises a switch network comprising one or two sets of N switches and one or two sets of N resistors; an op amp and a current buffer MOSFET. An input voltage is coupled to an input of the switch network; an output of the switch network is coupled to an input of the op amp; an output of the op amp is coupled to a control input of the current buffer MOSFET, which buffers the output current to the next stage. The output current is independent of the characteristics of the one or two sets of N switches.

To implement a single-ended converter, the switch network comprises one set of N resistors and one set of N switches. To implement a differential-ended converter, the switch network comprises two sets of N resistors and two sets of N switches.

### BRIEF DESCRIPTION OF THE DRAWINGS

The present embodiments may be better understood, and numerous objects, features, and advantages made apparent to those skilled in the art by referencing the accompanying drawings.

FIG. 1 illustrates an embodiment of a circuit with a filter, programmable V-I converter and a line driver;

FIG. 2 illustrates the functionality of a programmable V-I converter in a differential configuration;

FIG. 3A illustrates a single-ended embodiment of a programmable V-I converter according to one embodiment;

FIG. 3B illustrates the allowable states of operation for the embodiment of FIG. 3A;

FIG. 4A illustrates another single-ended embodiment of a programmable V-I converter according to one embodiment;

FIG. 4B illustrates the allowable states of operation for the embodiment of FIG. 4A;

FIG. 4C is a table showing the relationships between the operation of the MOSFET switch, the circuit status and the state for the embodiment of FIG. 4A;

FIG. 5 illustrates a differential embodiment of a programmable V-I converter according to one embodiment; and

FIG. 6 discloses a method for converting voltage to current with programmability for a single-ended and differential-ended converter, according to one embodiment.

The components in the figures are not necessarily to scale, emphasis instead being placed upon illustrating the principles of the present embodiments. In the figures, like reference numerals designate corresponding parts throughout the different views.

### DESCRIPTION OF EMBODIMENT(S)

A programmable voltage to current (V-I) converter may be implemented with a switching network. When the switches are set in a particular state, the switch network becomes a resistive ladder network. Some V-I converters may implement a switching network comprising parallel legs of resistors and MOS switches. The performance characteristics of the MOS switches may be a significant factor in the linear performance of the converter. The MOS switches may be designed with a large silicon area such that the resistance of the MOS switch in the “on” state is minimal compared with the resistor in the leg of the ladder in order to meet linearity objectives. As a result, the MOS switches are designed to minimize their resistance, thus increasing the silicon area and increasing the power consumption of the resistive ladder of the switch network.

In some embodiments, a V-I converter may be implemented where the output current signal path is constructed in such a way that the MOS switches are not part of the signal path in the resistive ladder. For example, the MOS switches used to program the V-I resistor network are eliminated from the signal path. Due to the elimination of the MOS switches from the signal path, the switching network may be designed very compact and independent of the V-I resistor value, and linear V-I conversion may be achieved. Also, one of the typical requirements of a high swing op amp may also be relaxed with this design.

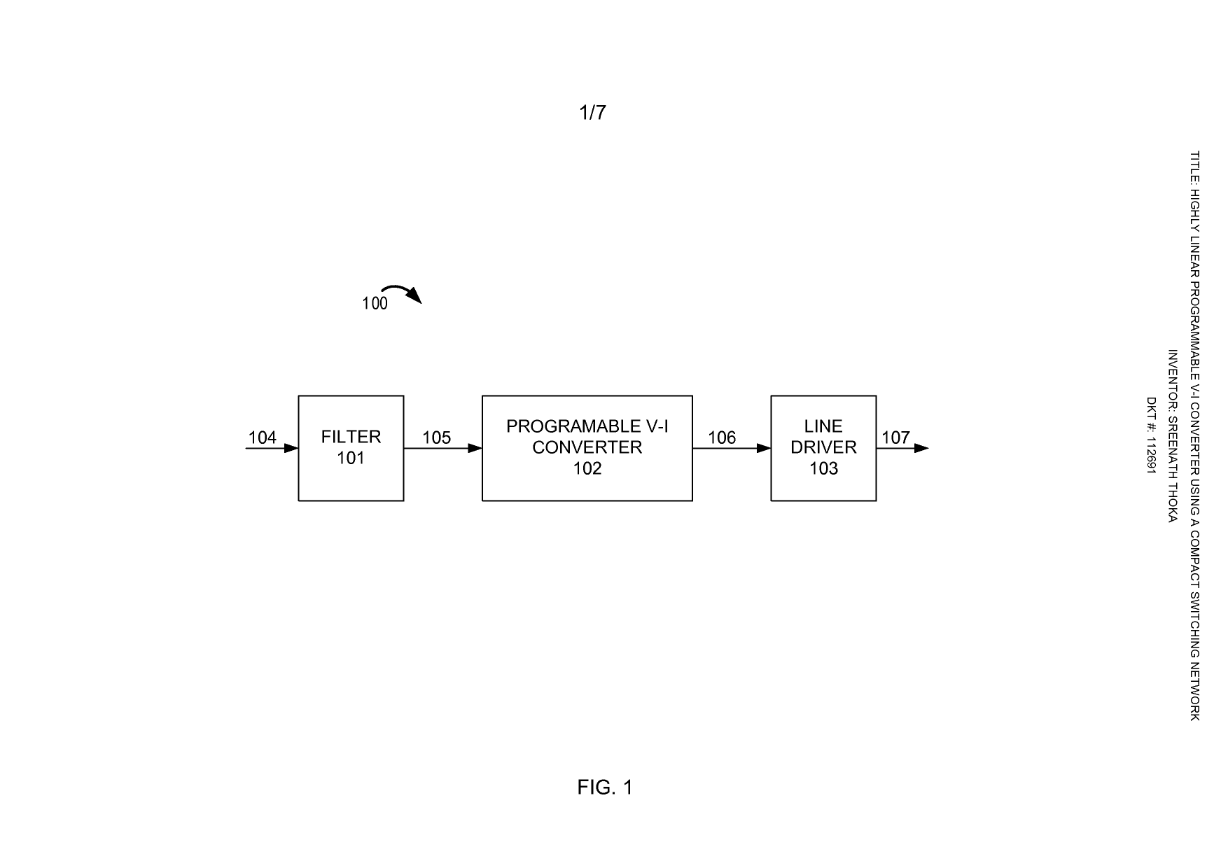

A programmable V-I converter may be used for a number of applications such as programming the transmitter gain. In this application, the programmable V-I converter may provide current to a line driver. An example of this application is illustrated in FIG. 1 with embodiment 100. Specifically, embodiment 100 illustrates a circuit with a filter 101, a programmable V-I converter 102 and a line driver 103. Signal 104 is coupled to filter 101 which generates filtered signal 105. Filtered signal 105 is coupled to programmable V-I converter 102 which generates output current 106. Output current 106 in turn is coupled to line driver 103 which generates output 107.

Depending on the system requirements, filter 101 may be designed as a number of filter types including Butterworth, elliptical or Chebyshev type filters. The main objective of the filter may be, for example, to attenuate DAC images. Based on the voltage input to the programmable V-I converter 102 and the programmable selection, the programmable V-I converter 102 generates the output current 106.

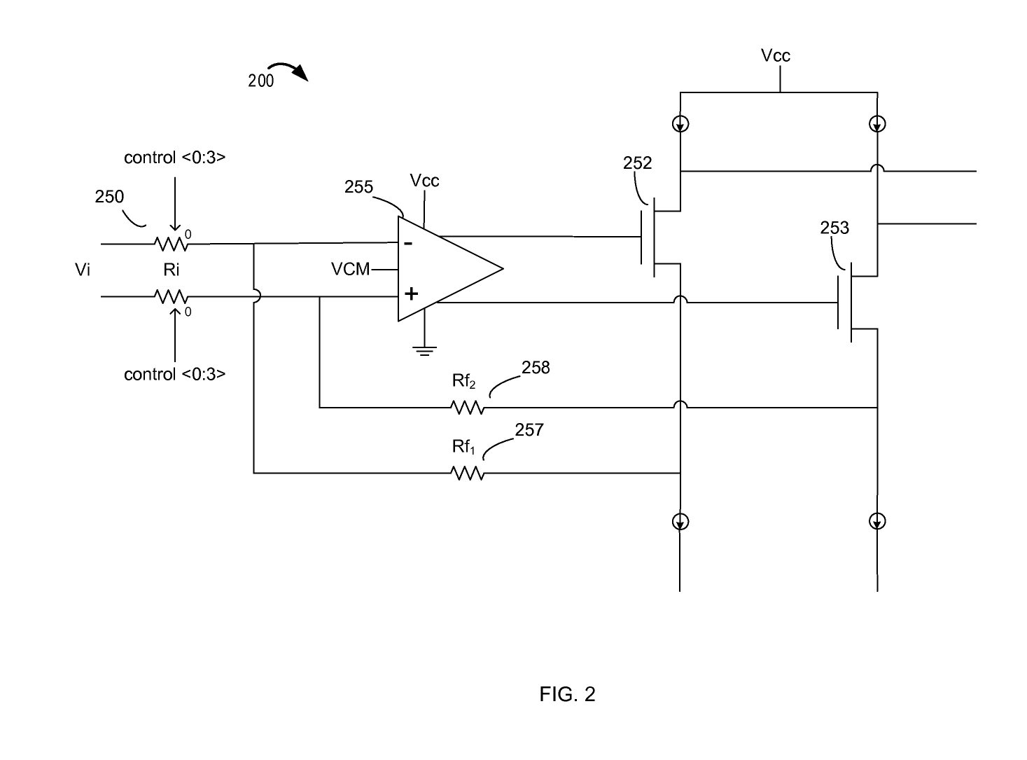

FIG. 2 illustrates the functionality of a programmable V-I converter in a differential configuration with embodiment 200, according to one embodiment. Ri represents the programmable V-I resistor 250 and Rf₁ and Rf₂ represents the feedback resistors 257 and 258, respectively, which represents the resistance of the MOS switch and any additional feedback resistance. Embodiment 200 incorporates fully differential amplifier (FDA) 255 with a common mode reference VCM. In one implementation, the input terminals of the FDA 255 are coupled to the programmable V-I resistor 250 and the differential output of the FDA 255 is coupled to N-type MOSFETs 252 and 253. For embodiment 200, the output current may vary, for example, from Vin/0.5K ohms to Vin/16.7K ohms based on the control setting of the programmable V-I resistor 250.

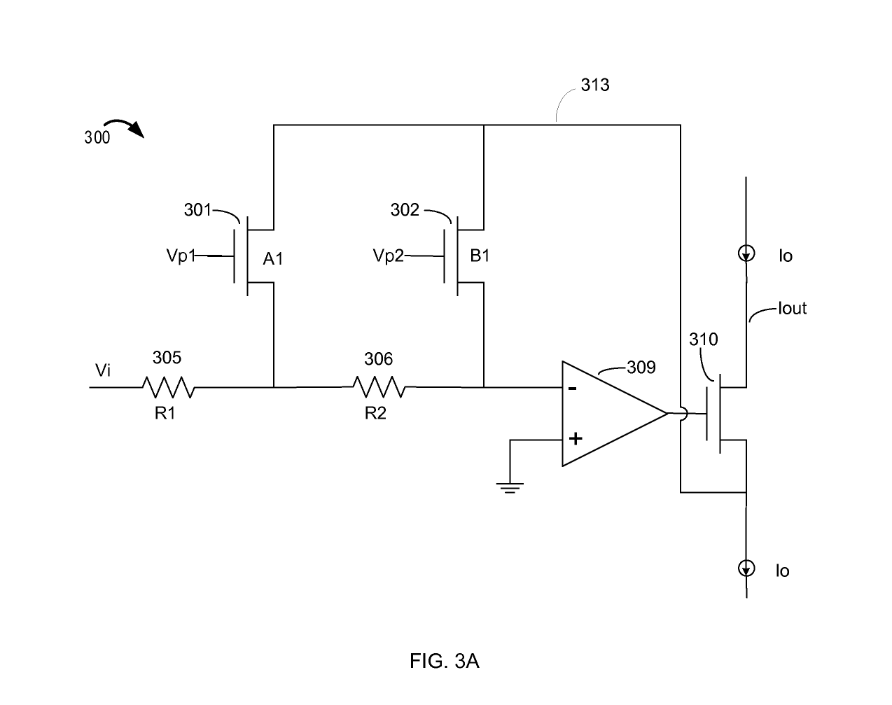

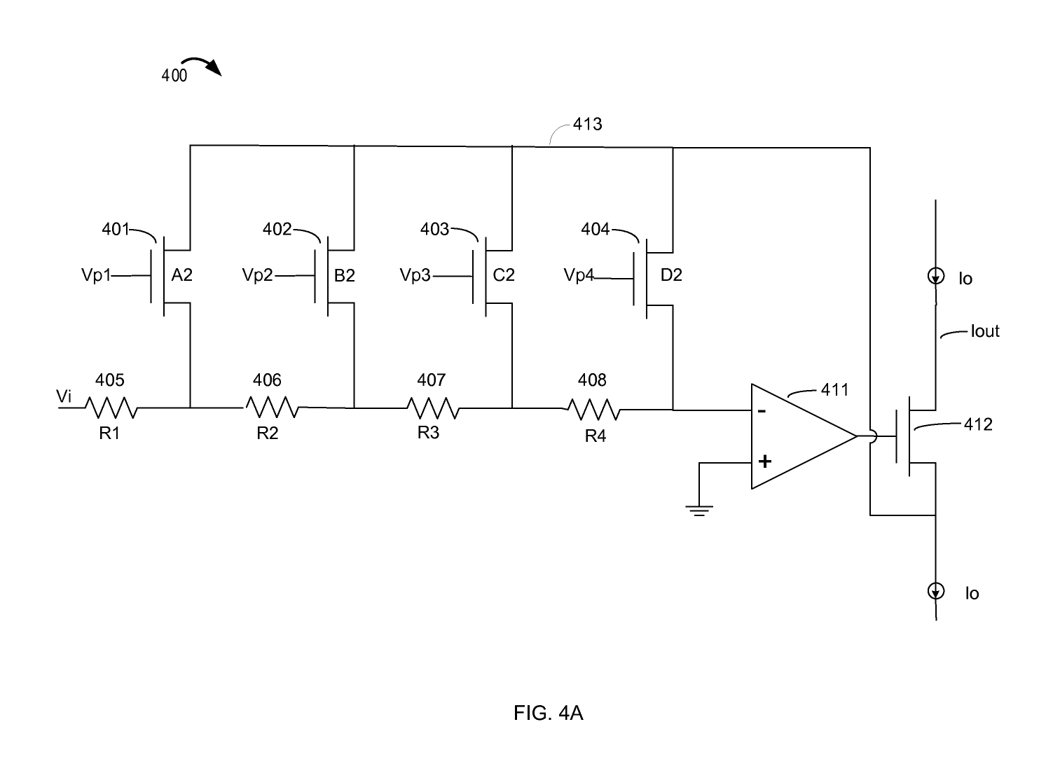

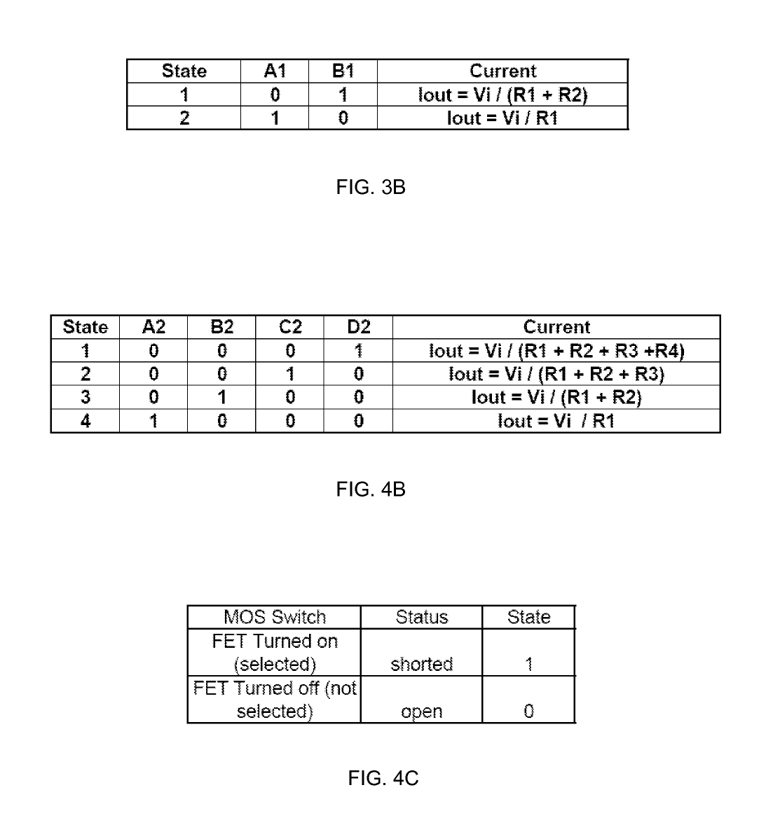

FIG. 3A illustrates a single-ended programmable V-I converter according to one embodiment. With embodiment 300 of FIG. 3A, the MOS switches that are used to program the switch network are eliminated from the signal path. The switch network comprises two MOS switches and two fixed resistors. Specifically, embodiment 300 comprises MOS switch 301 (A1) and MOS switch 302 (B1) (e.g., NMOS 301 and 302). MOS switch 301 is controlled by voltage Vp1 and MOS switch 302 is controlled by voltage Vp2. Embodiment 300 also comprises resistor 305 (R1) and resistor 306 (R2). An input voltage, Vi, is coupled to the switch network. Vi is coupled to the first input of 305 (R1). The second input of 305(R1) is coupled to the first terminal of MOS switch 301 (A1) and the first input of 306 (R2). And the second terminal of MOS switch 301 (A1) is coupled to feedback node 313. The second input of 306 (R2) is coupled to the first terminal of MOS switch 302 (B1) and to the first input terminal (inverting terminal) of an operational amplifier (op-amp) 309. The second input terminal (non-inverting terminal) of the op-amp 309 is coupled to ground. The second terminal of MOS switch 302 (B1) is also coupled to feedback node 313. The status of voltage Vp1 and voltage Vp2 (provided to the gate terminals of MOS switches 301 and 302, respectively) determines the output current Iout. The output of op amp 309 is coupled to the gate of MOSFET 310 (e.g., N-type MOSFET) which acts as a source follower for voltage feedback and as a current buffer for Iout.

If Vp1 turns on MOS switch 301, then MOS switch 301 is selected and the first end of MOS switch 301 is shorted to feedback node 313. In this case the state of A1=1. If Vp1 turns off MOS switch 301, then MOS switch 301 is not selected and is not shorted to feedback node 313. In this case, the state of A1=0. There is a similar relationship for MOS switch 302 and its state B1. FIG. 3B is a table showing the relationships between the operation of the MOSFET switch, the circuit status (e.g., the state of MOS switches 301 and 302) and the overall circuit state.

FIG. 3B illustrates the allowable states of operation for the embodiment of FIG. 3A. In State 1, MOS switch 301 is turned off (A1=0) and MOS switch 302 is turned on (B1=1). For this case, Iout=Vi/(R1+R2). In State 2, MOS switch 301 is turned on (A1=1) and MOS switch 302 is turned off (B1=0). For this case, Iout=Vi/R1. Note that the output current is independent of the characteristics of MOS switch 301 or MOS switch 302.

FIG. 4A illustrates another single-ended programmable V-I converter according to some embodiments. Embodiment 400 of FIG. 4A has four legs in the switch network as compared with embodiment 300 which has two legs. The switch network of embodiment 400 comprises four MOS switches and four fixed resistors. Specifically, embodiment 400 comprises MOS switch 401 (A2), MOS switch 402 (B2), MOS switch 403 (C2), and MOS switch 404 (D2) (e.g., NMOS 401-404). MOS switch 401 is controlled by voltage Vp1, MOS switch 402 is controlled by voltage Vp2, MOS switch 403 is controlled by voltage Vp3 and MOS switch 404 is controlled by voltage Vp4. Embodiment 400 also comprises resistor 405 (R1), resistor 406 (R2), resistor 407 (R3), and resistor 408 (R4). As shown, an input voltage, Vi, is coupled to the switch network. The status of Vp1, Vp2. Vp3 and Vp4 determines the output current, Iout. The output of op amp 411 is coupled to the gate of MOSFET 412 which acts as a current buffer for Iout. If Vp1 turns on MOS switch 401, then MOS switch 401 is selected and the first end of MOS switch 401 is shorted to feedback node 413. If Vp1 turns off MOS switch 401, then MOS switch 401 is not selected and is not shorted to feedback node 413. There are similar relationships for MOS switches 402, 403 and 404. In general, a programmable V-I converter may comprise a switch network comprising one or two sets of N switches and one or two sets of N resistors; an op amp, and a current buffer. For the embodiment of FIG. 4A, the V-I converter includes one set of N switches, and N=4, for example. The ith switch or ith resistor may be any of the four resistors or 4 switches.

FIG. 4B illustrates the allowable states of operation for the embodiment of FIG. 4A. In State 1, MOS switch 401 is turned off (A2=0), MOS switch 402 is turned off (B2=0), MOS switch 403 is turned off (C2=0) and MOS switch 404 is turned on (D2=1). For this case, Iout=Vi/(R1+R2+R3+R4). In State 2, MOS switch 401 is turned off (A2=0), MOS switch 402 is turned off (B2=0), MOS switch 403 is turned on (C2=1) and MOS switch 404 is turned off (D2=0). For this case, Iout=Vi/(R1+R2+R3). In State 3, MOS switch 401 is turned off (A2=0), MOS switch 402 is turned on (B2=1), MOS switch 403 is turned off (C2=0) and MOS switch 404 is turned off (D2=0). For this case, Iout=Vi/(R1+R2). In State 4, MOS switch 401 is turned on (A2=1), MOS switch 402 is turned off (B2=0), MOS switch 403 is turned off (C2=0) and MOS switch 404 is turned off (D2=0). For this case, Iout=Vi/R1. Note that the output current is independent of the characteristics of MOS switch 401, MOS switch 402, MOS switch 403 and MOS switch 404. FIG. 4C is a table showing the relationships between the operation of the MOSFET switch, the circuit status and the state.

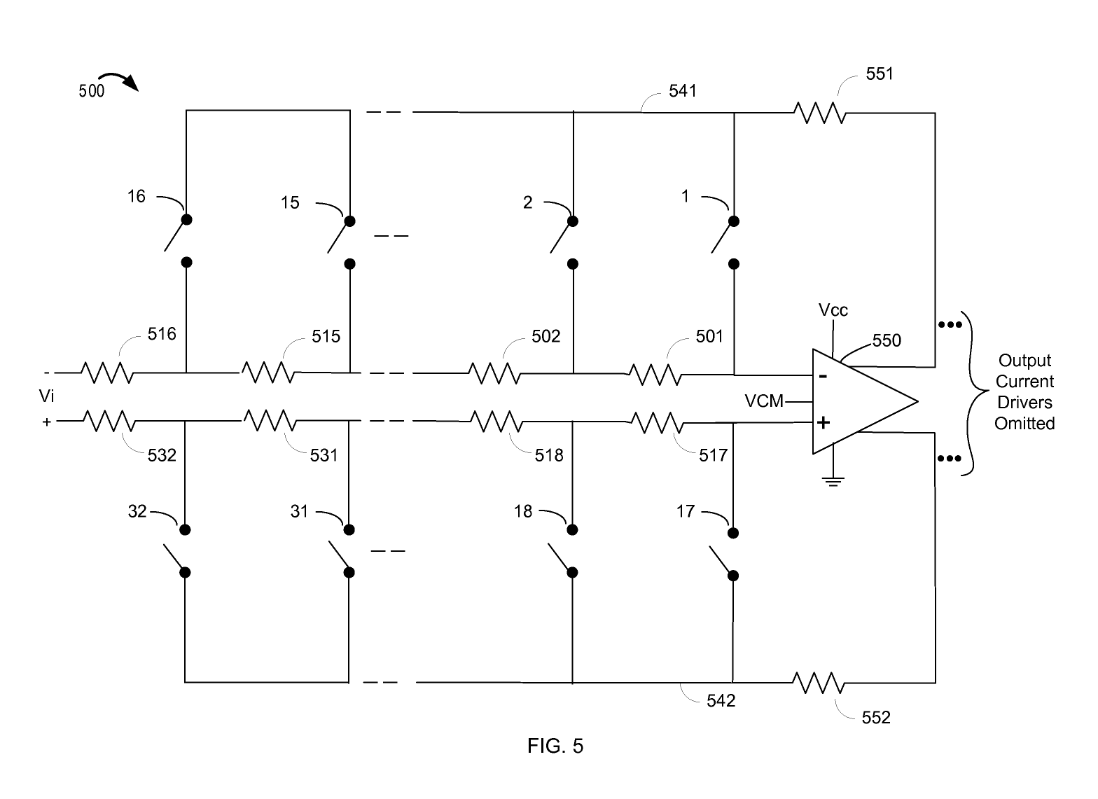

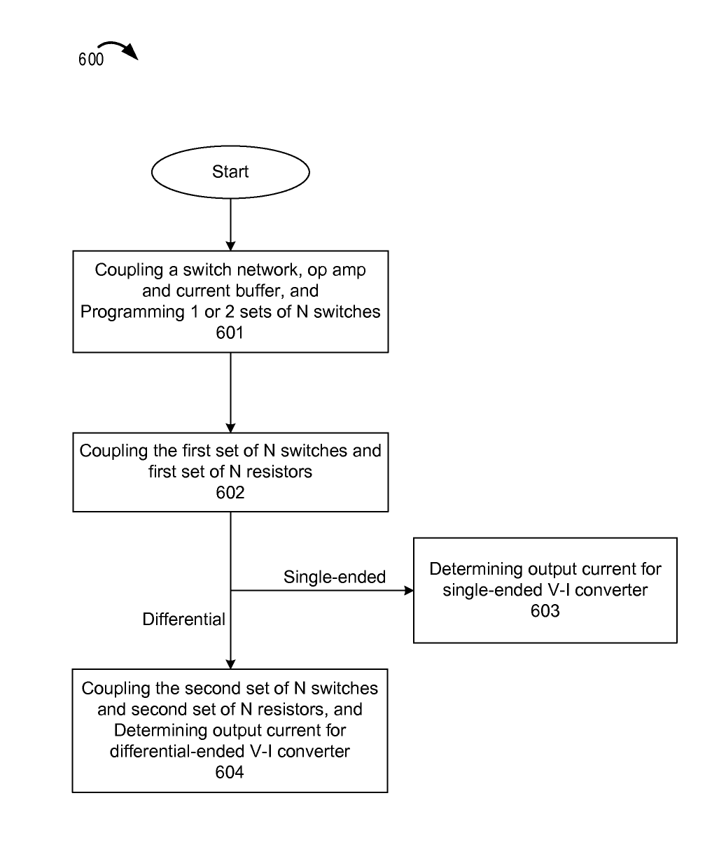

FIG. 5 illustrates a differential-ended programmable V-I converter according to some embodiments. Embodiment 500 of FIG. 5 comprises 32 legs in the switch network, 16 legs supporting the negative input of the fully differential amplifier (FDA) 550, and 16 legs supporting the positive input of the FDA 550. In the embodiment shown in FIG. 5, the differential-ended programmable V-I converter comprises two sets of N switches and two sets of N resistors. In one specific implementation, N may be equal to 16. As illustrated in FIG. 5, the first set of N switches may include switches 1-16 (e.g., NMOS transistors) and the first set of N resistors may include resistors 501-516. The second set of N switches may include switches 17-32 (e.g., NMOS transistors) and the second set of N resistors may include resistors 517-532. As shown, the FDA 550 has a common mode reference voltage, VCM. Voltage Vi is coupled to the inputs of the differential-ended switch network. The embodiment 500 also comprises two fixed resistors 551 and 552, which represent feedback resistances in addition to the switch resistances, and that are coupled to the feedback nodes 541 and 542, respectively. The output current drivers are not shown in the embodiment 500. It is noted that various types and designs of output current drivers may be used with the embodiment of FIG. 5 (and also the embodiments of FIGS. 3A and 4A).

In general, in some embodiments, a single-ended or differential-ended programmable V-I converter comprises a switch network comprising one or two sets of N switches and one or two sets of N resistors; an op amp; and a current buffer. To operate, an input voltage is coupled to input of the switch network, wherein an output of the switch network is coupled to an input of the op amp, wherein an output of the op amp is coupled to a control input of the current buffer MOSFET wherein the current buffer buffers the output current, wherein the output current is independent of characteristics of the one or two sets of N switches.

In some embodiments, for a single-ended programmable V-I converter, the converter comprises a first set of N resistors coupled to a first set of N switches, wherein second end of ith resistor is coupled (1) to a first end of ith switch and (2) to first end (i+1)th resistor, wherein i is less than N, and wherein Nth resistor of the first set of the N resistors is coupled to a first end of Nth switch and to a first input of an op amp, wherein a second end of the N switches is coupled to a feedback node, such as feedback node 541. An input voltage is coupled to first end of first resistor of the first set of the N resistors; and programmable voltages are coupled to control inputs of the first set of N switches, wherein one of the N switches is selected and couples the first end of selected switch to the feedback node, such as feedback node 541. Further, a second input of the op amp is coupled to ground, wherein if the ith switch is selected, the output current is equal to the input voltage divided by sum of value of resistors comprising sequence from the first resistor to the ith resistor. The aforementioned programmable V-I converter describes a single-ended programmable V-I converter.

In some embodiments, a differential-ended programmable V-I converter comprises the elements described above for a single-ended programmable V-I converter plus the following elements.

In some embodiments, a differential-ended programmable V-I converter further comprises a second set of N resistors coupled to a second set of N switches, wherein the second end of ith resistor is coupled (1) to the first end of ith switch and (2) to first end (i+1)th resistor, wherein i is less than N, and wherein Nth resistor of the second set of N resistors is coupled to the first end of Nth switch and to a second input of the op amp, wherein the second end of the N switches is coupled to a second feedback node, such as feedback node 542. In some embodiments, the second set of N resistors and N switches have same relative coupling and same relative values as the first set of N resistors and N switches. The input voltage is coupled to first end of first resistor of the second set of N resistors; and the programmable voltages are coupled to control inputs of the second set of N switches, wherein the ith switch is selected and couples the first end of the selected switch to the second feedback node, such as feedback node 542. I If the ith switch is selected in the first set of N resistors and N switches and the ith switch is selected in the second set of N resistors and N switches, output current is equal to the input voltage divided by sum of the value of resistors comprising a first sequence from the first resistor to the ith resistor of the first set of N resistors, minus the input voltage divided by sum of the value of resistors comprising a second sequence from the first resistor to the ith resistor of the second set of N resistors. The aforementioned programmable V-I converter describes a differential-ended programmable V-I converter.

The N switches of the programmable V-I converter as described above may be implemented with N MOSFETs. Also, the programmable V-I converter may be an integrated circuit.

FIG. 6 discloses a method for converting V-I with programmability for a single-ended and differential-ended converter, according to some embodiments. In one embodiment, the method 600 comprises Steps 601-604 described below.

In one implementation, Step 601 includes programming one set of N switches for a single-ended V-I converter, and programming two sets of N switches for a differential-ended V-I converter. An input voltage is coupled to a switch network, which comprises either the one set of N switches for a single-ended V-I converter or the two sets of N switches for a differential-ended V-I converter. The output of the switch network is coupled to an op amp, and the output of the op amp is coupled to a current buffer, which then buffers an output current. The output current is independent of the characteristics of the switch network.

In one implementation, Step 602 includes coupling a first set of N resistors to a first set of N switches, which comprises a second end of the ith resistor coupled (1) to a first end of the ith switch and (2) to a first end of the (i+1)th resistor, where i is less than N, and where the Nth resistor of the first set of the N resistors is coupled to a first end of the Nth switch and to a first input terminal of an op amp. A second input terminal of the op amp is coupled to ground. A second end of each of the N switches is coupled to a feedback node, such as the feedback node 413. A first end of the first resistor of the first set of N resistors is coupled to receive an input voltage. Also, control input terminals of the first set of N switches are coupled to receive programmable voltages. In response to receiving the programmable voltages at the first set of N switches, one of the N switches is selected based on the received programmable voltages and a first end of the selected switch is coupled to the feedback node, such as the feedback node 413. In one example, the first end of the selected switch is shorted to the feedback node, such as the feedback node 413.

In one implementation, Step 603 includes, if the ith switch is selected based on the received programmable voltages, determining the output current by dividing the input voltage by a sum of the value of resistors comprising a sequence from the first resistor to the ith resistor.

In one implementation, Step 604 includes coupling a second set of N resistors to a second set of N switches, which comprises a second end of the ith resistor coupled (1) to a first end of the ith switch and (2) to a first end of the (i+1)th resistor, where i is less than N, and where the Nth resistor of the second set of N resistors is coupled to a first end of Nth switch and to a second input terminal of the op amp. A second end of each of the N switches is coupled to a second feedback node, such as the feedback node 542. A first end of first resistor of the second set of N resistors is also coupled to receive the input voltage. Also, control input terminals of the second set of N switches are coupled to receive second programmable voltages. In response to receiving the second programmable voltages at the second set of N switches, one of the second set of N switches is selected based on the second programmable voltages and a first end of the selected switch is coupled to the second feedback node, such as the feedback node 542. In one implementation, if the ith switch is selected in the first set of N resistors and N switches and the ith switch is selected in the second set of N resistors and N switches, the output current is equal to the input voltage divided by a sum of value of resistors comprising a first sequence from the first resistor to the ith resistor of the first set of N resistors, minus the input voltage divided by a sum of value of resistors comprising a second sequence from the first resistor to the ith resistor of the second set of N resistors. In one example, the second set of N resistors and N switches have the same relative coupling and the same values as the first set of N resistors and N switches.

It should be understood that FIGS. 1-6 are examples meant to aid in understanding embodiments and should not be used to limit embodiments or limit scope of the claims. Embodiments may comprise additional circuit components, different circuit components, may perform additional operations, fewer operations, operations in a different order, operations in parallel, and some operations differently. For example, although some of the embodiments shown in FIGS. 1-6 include N-type MOSFETs, in other implementations, the switches and/or current buffer may be P-type MOSFETs.

While the embodiments are described with reference to various implementations and exploitations, it will be understood that these embodiments are illustrative and that the scope of the inventive subject matter is not limited to them. In general, a linear programmable V-I converter using a compact switch network as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A programmable voltage to current converter comprising:
a first set of N resistors coupled to a first set of N switches, wherein a second end of ith resistor is coupled to a first end of ith switch and to a
first end of (i+1)th resistor, wherein i is less than N, and wherein Nth resistor of the first set of the N resistors is coupled to a first end of
Nth switch and to a first input terminal of an op amp, wherein a second end of each of the N switches is coupled to a feedback node;
a first end of a first resistor of the first set of the N resistors is coupled to receive an input voltage; and
control input terminals of the first set of N switches are coupled to receive programmable voltages.

2. The programmable voltage to current converter of claim 1, wherein, in response to receiving the programmable voltages at the first set of N switches, one of the N switches is selected based on the received programmable voltages and a first end of the selected switch is coupled to the feedback node.

3. The programmable voltage to current converter of claim 2,
wherein a second input terminal of the op amp is coupled to ground,
wherein if the ith switch is selected based on the received programmable voltages, an output current is equal to the input voltage divided by a sum of value of resistors comprising sequence from the first resistor to the ith resistor.

4. The programmable voltage to current converter of claim 3, wherein an output terminal of the op amp is coupled to a current buffer.

5. The programmable voltage to current converter of claim 1, further comprising:
a second set of N resistors coupled to a second set of N switches, wherein a second end of ith resistor is coupled to a first end of ith switch and to a
first end of (i+1)th resistor, wherein i is less than N, and wherein Nth resistor of the second set of N resistors is coupled to a first end of
Nth switch and to a second input terminal of the op amp, wherein a second end of each of the N switches is coupled to a second feedback node,
a first end of a first resistor of the second set of N resistors is coupled to receive the input voltage; and
control input terminals of the second set of N switches are coupled to receive second programmable voltages.

6. The programmable voltage to current converter of claim 5, wherein, in response to receiving the second programmable voltages at the second set of N switches, one of the second set of N switches is selected based on the second programmable voltages and a first end of the selected switch is coupled to the second feedback node.

7. The programmable voltage to current converter of claim 5, wherein if ith switch is selected in the first set of N resistors and N switches and the ith switch is selected in the second set of N resistors and N switches, output current is equal to the input voltage divided by a sum of value of resistors comprising a first sequence from the first resistor to the ith resistor of the first set of N resistors, minus the input voltage divided by a sum of value of resistors comprising a second sequence from the first resistor to the ith resistor of the second set of N resistors.

8. The programmable voltage to current converter of claim 5, wherein the first set and second set of N switches are N-type MOSFETs.

9. The programmable voltage to current converter of claim 5 is an integrated circuit.

10. The programmable voltage to current converter of claim 5, wherein the second set of N resistors and N switches have same relative coupling and same relative values as the first set of N resistors and N switches.

11. A method of converting voltage to current comprising:
programming one or two sets of N switches;
coupling an input voltage to a switch network, the switch network comprises the one or two sets of N switches and one or two sets of N resistors;
coupling an output of the switch network to an op amp; and
coupling an output of the op amp to a current buffer,
wherein the current buffer is configured to buffer an output current,
wherein the output current is independent of characteristics of the one or two sets of N switches.

12. The method of claim 11, further comprising:
coupling a first set of N resistors to a first set of N switches, wherein a second end of ith resistor is coupled to a first end of ith switch and to a
first end of (i+1)th resistor, wherein i is less than N, and wherein Nth resistor of the first set of the N resistors is coupled to a first end of
Nth switch and to a first input terminal of an op amp,
wherein a second end of each of the N switches is coupled to a feedback node;
coupling programmable voltages to control input terminals of the first set of N switches and selecting one of the first set of N switches; and
coupling a first end of selected switch to the feedback node.

13. The method of claim 12, further comprising:
coupling a second input of the op amp to ground; and
determining the output current by dividing the input voltage by summing value of resistors comprising sequence from first resistor to the ith resistor.

14. The method of claim 12, further comprising:
coupling a second set of N resistors to a second set of N switches, wherein a second end of ith resistor is coupled to a first end of ith switch and to a
first end of (i+1)th resistor, wherein i is less than N, and wherein Nth resistor of the second set of N resistors is coupled to a first end of
Nth switch and to a second input terminal of the op amp, wherein a second end of each of the N switches is coupled to a second feedback node,
wherein the second set of N resistors and N switches have same relative coupling and same relative values as the first set of N resistors and N switches;
coupling the input voltage to a first end of first resistor of the second set of N resistors; and
coupling second programmable voltages to control input terminals of the second set of N switches,
wherein one of the second set of N switches is selected and a first end of selected switch is coupled to the second feedback node.

15. The method of claim 14, wherein if ith switch is selected in the first set of N resistors and N switches and if ith switch is also selected from the second set of N resistors and N switches, output current is equal to the input voltage divided by sum of value of resistors comprising a first sequence from the first resistor to the ith resistor of the first set of N resistors, minus the input voltage divided by sum of value of resistors comprising a second sequence from the first resistor to the ith resistor of the second set of N resistors.

16. A programmable voltage to current converter comprising:
a switch network comprising a first set of N switches coupled to a first set of N resistors;
an op amp;
a current buffer MOSFET;
an input of the switch network is coupled to receive an input voltage;
an output of the switch network is coupled to a first input terminal of the op amp; and
an output terminal of the op amp is coupled to a control input of the current buffer MOSFET,
wherein the current buffer MOSFET is coupled to buffer an output current at an output terminal of the programmable voltage to current converter,
wherein the output current is independent of characteristics of the first set of N switches.

17. The programmable voltage to current converter of claim 16, wherein the first set of N switches coupled to the first set of N resistors of the switch network further comprises:
a second end of ith resistor is coupled to a first end of ith switch and to a first end (i+1)th resistor, wherein i is less than N;
Nth resistor of the first set of the N resistors is coupled to a first end of Nth switch and to the first input terminal of the op amp;
a second end of each of the N switches is coupled to a feedback node;
a first end of a first resistor of the first set of the N resistors is coupled to receive the input voltage at the input of the switch network; and
control input terminals of the first set of N switches are coupled to receive programmable voltages.

18. The programmable voltage to current converter of claim 17, wherein, in response to receiving the programmable voltages at the first set of N switches, one of the N switches is selected based on the received programmable voltages and a first end of the selected switch is coupled to the feedback node.

19. The programmable voltage to current converter of claim 18,
wherein a second input terminal of the op amp is coupled to ground,
wherein if the ith switch is selected based on the received programmable voltages, the output current is equal to the input voltage divided by a sum of value of resistors comprising sequence from the first resistor to the ith resistor.

20. The programmable voltage to current converter of claim 17, wherein the switch network further comprises:
a second set of N resistors coupled to a second set of N switches,
wherein a second end of ith resistor is coupled to a first end of ith switch and to a first end of (i+1)th resistor, wherein i is less than N, and
wherein Nth resistor of the second set of N resistors is coupled to a first end of Nth switch and to a second input terminal of the op amp,
wherein a second end of each of the N switches is coupled to a second feedback node,
a first end of a first resistor of the second set of N resistors is coupled to receive the input voltage; and
control input terminals of the second set of N switches are coupled to receive second programmable voltages.

21. The programmable voltage to current converter of claim 20, wherein the second set of N resistors and N switches have same relative coupling and same relative values as the first set of N resistors and N switches of the switch network.

22. The programmable voltage to current converter of claim 20, wherein, in response to receiving the second programmable voltages at the second set of N switches, one of the second set of N switches is selected based on the second programmable voltages and a first end of the selected switch is coupled to the second feedback node.

23. The programmable voltage to current converter of claim 20, wherein if ith switch is selected in the first set of N resistors and N switches and the ith switch is selected in the second set of N resistors and N switches, the output current is equal to the input voltage divided by a sum of value of resistors comprising a first sequence from the first resistor to the ith resistor of the first set of N resistors, minus the input voltage divided by a sum of value of resistors comprising a second sequence from the first resistor to the ith resistor of the second set of N resistors.
